(19) United States
(12) Patent Application Publication
(10) Pub. No.: US 2013/0285901 A1
(43) Pub. Date: Oct. 31, 2013

(54) SYSTEM AND METHOD FOR TRACKING GAZE AT DISTANCE

(71) Applicants: Electronics and Telecommunications Research Institute, (US); Dongguk University Industry-Academic Cooperation Foundation, (US)

(72) Inventors: Hee Kyung LEE, Daejeon (KR); In Jae LEE, Daejeon (KR); Ji Hun CHA, Daejeon (KR); Kang Ryoung PARK, Seoul (KR); Chul Woo CHO, Seoul (KR); Su Yeong GWON, Seoul (KR); Hyeon Chang LEE, Seoul (KR); Won Oh LEE, Seoul (KR)

(73) Assignees: Dongguk University Industry-Academic Cooperation Foundation, Seoul (KR); Electronics and Telecommunications Research Institute, Daejeon (KR)

(21) Appl. No.: 13/870,321

(22) Filed: Apr. 25, 2013

(30) Foreign Application Priority Data
Apr. 27, 2012 (KR) 10-2012-0044380

(51) Int. Cl. G06F 3/01

(52) U.S. Cl. CPC G06F 3/013
USPC 345/156

(57) ABSTRACT

A system and method for tracking a gaze at a distance are provided. A remote gaze tracking system may include an infrared lighting unit including a plurality of infrared lightings to emit an infrared light toward a user, a gaze tracking module to track a position of a face of the user, and to collect, from the tracked position of the face, an eye image including at least one reflected light among a plurality of corneal reflected lights and a lens-reflected light, the corneal reflected lights being reflected from a cornea by the emitted infrared light, and the lens-reflected light being reflected from a lens of glasses, and a processor to compare a magnitude of the lens-reflected light with a threshold in the collected eye image, and when the magnitude of the lens-reflected light is equal to or less than the threshold, to detect coordinates of a center of each of the plurality of corneal reflected lights, and to calculate a gaze position.

### CROSS-REFERENCE TO RELATED APPLICATION

This application claims the benefit of Korean Patent Application No. 10-2012-0044380, filed on Apr. 27, 2012, in the Korean Intellectual Property Office, the disclosure of which is incorporated herein by reference.

### BACKGROUND

1. Field of the Invention

The present invention relates to a technology that may remove a light reflected from a lens of glasses by an infrared lighting, to eliminate a gaze tracking error caused by the reflected light, in a gaze tracking apparatus for tracking a gaze of a user wearing the glasses using the infrared light.

2. Description of the Related Art

Gaze tracking refers to a scheme of analyzing a position at which a user stares.

The gaze tracking may have advantages, for example, a similarity to a conventional mouse operation method protocol, an immediacy indicating that a place a user looks may be immediately pointed out, a convenience indicating that a function of an input device may be provided to a hand-impaired user, an immersion provided by adjusting a view screen based on a direction of a user's gaze in a virtual reality environment, and the like.

A gaze tracking method includes a method of calculating a gaze position in a non-wearable manner by installing a camera and a lighting outside, unlike a method of mounting a camera on a head of a user.

A method of tracking a gaze using a lighting may perform gaze tracking, using central position coordinate information of corneal reflected lights 101, 102, 103 and 104 of FIG. 1 that are reflected from a cornea on a center of a pupil of a user and on a surface of the pupil, as indicated by reference numeral 110. In this instance, when the user wears glasses, a lens-reflected light 121 that is reflected from a lens of the glasses by the lighting may cover the pupil or a reflected light on the pupil, as indicated by reference numeral 120.

When the lens-reflected light 121 covers the pupil or the reflected light on the pupil, as indicated by reference numeral 120, an error may occur during calculation of a gaze position.

### SUMMARY

According to an aspect of the present invention, there is provided a remote gaze tracking system, including: an infrared lighting unit including a plurality of infrared lightings to emit an infrared light toward a user; a gaze tracking module to track a position of a face of the user, and to collect, from the tracked position of the face, an eye image including at least one reflected light among a plurality of corneal reflected lights and a lens-reflected light, the corneal reflected lights being reflected from a cornea by the emitted infrared light, and the lens-reflected light being reflected from a lens of glasses; and a processor to compare a magnitude of the lens-reflected light with a threshold in the collected eye image, and when the magnitude of the lens-reflected light is equal to or less than the threshold, to detect coordinates of a center of each of the plurality of corneal reflected lights, and to calculate a gaze position.

According to another aspect of the present invention, there is provided a remote gaze tracking system, including: an infrared lighting unit including a plurality of infrared lightings to emit an infrared light toward a user; a gaze tracking module to track a position of a face of the user, and to collect, from the tracked position of the face, an eye image generated by the emitted infrared light; and a processor to detect a lens-reflected light from the collected eye image, and to determine whether the user wears glasses.

According to another aspect of the present invention, there is provided a remote gaze tracking method, including: emitting an infrared light toward a user, using a plurality of infrared lightings; tracking a position of a face of the user, and collecting, from the tracked position of the face, an eye image including at least one reflected light among a plurality of corneal reflected lights and a lens-reflected light, the corneal reflected lights being reflected from a cornea by the emitted infrared light, and the lens-reflected light being reflected from a lens of glasses; and comparing a magnitude of the lens-reflected light with a threshold in the collected eye image, and when the magnitude of the lens-reflected light is equal to or less than the threshold, detecting coordinates of a center of each of the plurality of corneal reflected lights, and calculating a gaze position.

### EFFECT

According to embodiments of the present invention, it is possible to remove a light reflected from a lens of glasses by a lighting, to eliminate an error caused by the reflected light, for example an error in coordinates of a center of a pupil, and an error in coordinates of a center of a light reflected from the pupil, in a gaze tracking apparatus, when a user wears the glasses.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a problem of a lens-reflected light that may occur from a user wearing glasses, in a conventional gaze tracking;

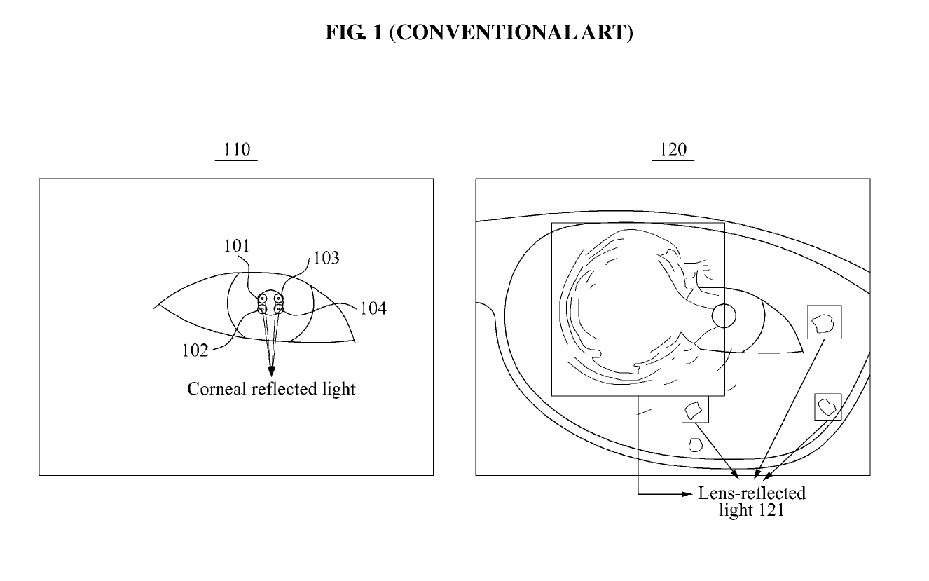

FIG. 2 is a block diagram illustrating a remote gaze tracking system according to an embodiment of the present invention;

FIG. 3 is a diagram illustrating a remote gaze tracking system according to an embodiment of the present invention; and

FIG. 4 is a flowchart illustrating a remote gaze tracking method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

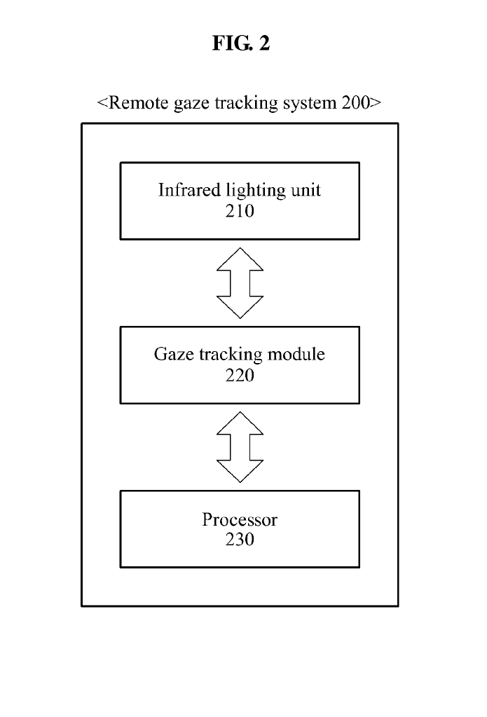

FIG. 2 is a block diagram illustrating a remote gaze tracking system 200 according to an embodiment of the present invention.

The remote gaze tracking system 200 of FIG. 2 may include an infrared lighting unit 210, a gaze tracking module 220, and a processor 230.

The infrared lighting unit 210 may include a plurality of infrared lightings to emit an infrared light toward a user.

The plurality of infrared lightings in the infrared lighting unit 210 may include, for example, an infrared lighting located in an upper left end of a display, an infrared lighting located in a lower left end of the display, an infrared lighting located in an upper right end of the display, and an infrared lighting located in a lower right end of the display.

The gaze tracking module 220 may track a position of a face of the user, and may collect, from the tracked position of the face, an eye image including at least one reflected light among a plurality of corneal reflected lights and a lens-reflected light. In this instance, the corneal reflected lights may refer to lights reflected from a cornea by the emitted infrared light, and the lens-reflected light may refer to a light reflected from a lens of glasses.

The processor 230 may compare a magnitude of the lens-reflected light with a threshold in the collected eye image. When the magnitude of the lens-reflected light is equal to or less than the threshold, the processor 230 may detect coordinates of a center of each of the plurality of corneal reflected lights, and may calculate a gaze position.

For example, when the magnitude of the lens-reflected light is equal to or less than the threshold, the processor 230 may control the plurality of infrared lightings, so that a number of infrared lights emitted toward the user may be adjusted.

Specifically, the processor 230 may control an on state and/or off state of the plurality of infrared lightings, and may adjust the number of the emitted infrared lights. Additionally, the processor 230 may calculate the gaze position, using an on state and/or off state of the plurality of infrared lightings corresponding to a lens-reflected light with a smallest magnitude among at least one lens-reflected light generated by the adjusted infrared light.

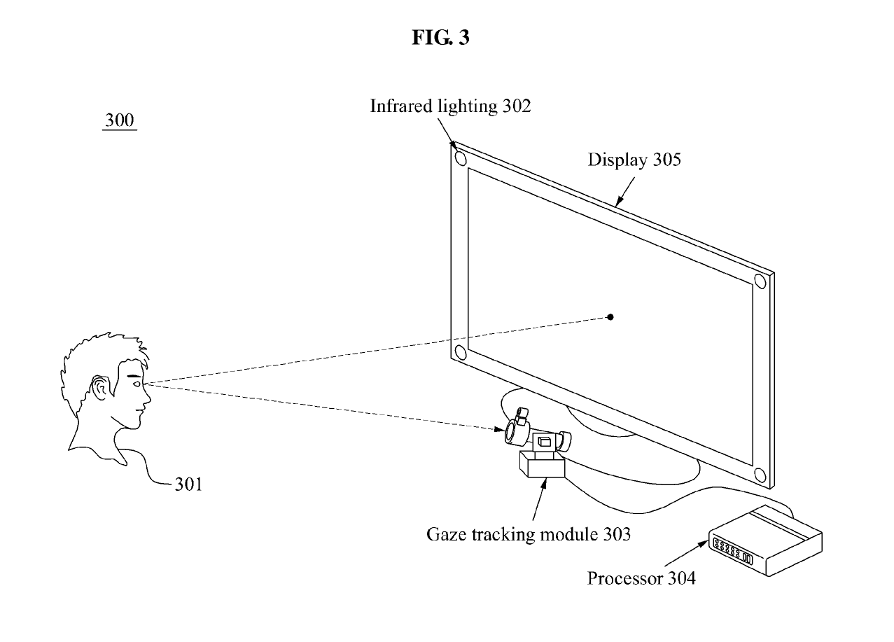

FIG. 3 is a diagram illustrating a remote gaze tracking system 300 according to an embodiment of the present invention.

The remote gaze tracking system 300 of FIG. 3 is provided to explain a configuration of a gaze tracking apparatus to apply a lens-reflected light removal algorithm proposed by the present invention.

A gaze tracking module 303 of FIG. 3 may include a wide angle camera and a narrow angle camera.

First, the wide angle camera may recognize a position of a face of a user, and the narrow angle camera and the wide angle camera may be panned and tiled based on the position of the face. Additionally, the narrow angle camera may acquire an eye image of the user.

A processor 304 of FIG. 3 may detect, from the eye image acquired by the narrow angle camera, coordinates of a center of a pupil, and coordinates of a center of each of four corneal reflected lights that are generated by four infrared lightings 302 attached on a display 305. Subsequently, the processor 304 may calculate a gaze position using geometric transform.

However, when a user wears glasses, a light may be reflected from a lens of the glasses by an infrared lighting, and the reflected light may cover a pupil of the user, or a corneal reflected light on the pupil. In other words, when a light reflected from a lens of glasses covers a center of a pupil or a corneal reflected light, a large number of errors may occur in calculation of a position of a user's gaze, or detection may be impossible.

To solve the above problem, the processor 304 may remove the light reflected from the lens of the glasses.

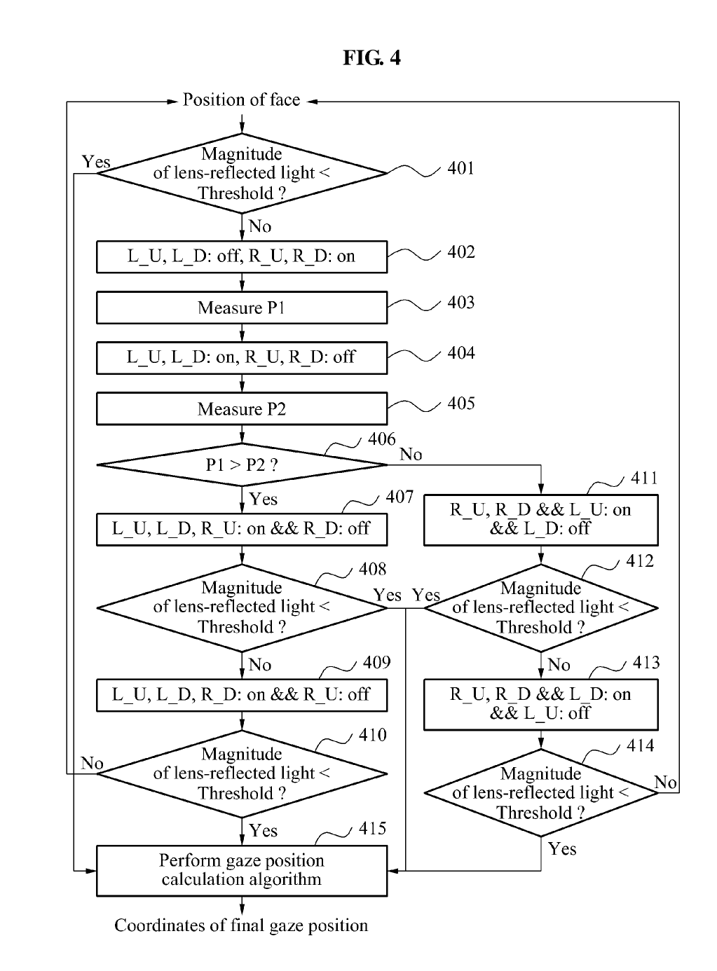

FIG. 4 is a flowchart illustrating a remote gaze tracking method according to an embodiment of the present invention.

In the remote gaze tracking method of FIG. 4, a face image may be received as an input using a wide angle camera of a gaze tracking module, and a position of a face may be detected from the received face image. Additionally, an eye image may be received as an input, using a narrow angle camera of the gaze tracking module, a number of pixels that each have a gray level equal to or greater than a predetermined value may be measured, and whether a user wears glasses may be determined based on the measured number of the pixels.

Referring to FIG. 4, in operation 401, a measured magnitude of a lens-reflected light reflected from a lens of glasses may be compared with a set threshold, and whether the magnitude of the lens-reflected light is less than the threshold may be determined

When the magnitude of the lens-reflected light is determined to be less than the threshold in operation 401, the lens-reflected light may be determined to have no influence on calculation of a gaze position, and coordinates of a final gaze position in which a user is interested may be obtained using a gaze position calculation algorithm in operation 415.

When the magnitude of the lens-reflected light is determined to be greater than the threshold in operation 401, the lens-reflected light may be determined to cover a pupil, or a corneal reflected light on the pupil, and a lens-reflected light removal algorithm may be performed.

To perform the lens-reflected light removal algorithm, two left lightings L_U and L_D may be turned off, and two right lightings R_U and R_D may be turned on in operation 402.

In operation 403, a number of pixels in an eye image that each have a gray level equal to or greater than a predetermined value may be measured, and a magnitude P1 of a lens-reflected light may be measured in the eye image. In operation 404, the two right lightings R_U and R_D may be turned off, and the two left lightings L_U and L_D may be turned on.

In operation 405, a number of pixels in the eye image that each have a gray level equal to or greater than a predetermined value may be measured, and a magnitude P2 of a lens-reflected light may be measured in the eye image.

In operation 406, P1 and P2 may be compared. When P1 is determined to be greater than P2 in operation 406, a right lighting may be determined to generate a reflected light, the two left lightings L_U and L_D and the upper right lighting R_U may be turned on, and the lower right lighting R_D may be turned off in operation 407.

In operation 408, a magnitude of another lens-reflected light may be measured, and may be compared with the threshold.

When the magnitude of the lens-reflected light is determined to be less than the threshold in operation 408, the coordinates of the final gaze position may be obtained using the gaze position calculation algorithm in operation 415.

When the magnitude of the lens-reflected light is determined to be greater than the threshold in operation 408, the two left lightings L_U and L_D and the lower right lighting R_D may be turned on, and the upper right lighting R_U may be turned off in operation 409.

In operation 410, a magnitude of another lens-reflected light may be measured, and may be compared with the threshold. When the magnitude of the lens-reflected light is determined to be less than the threshold in operation 410, the gaze position calculation algorithm may be performed in operation 415. When the magnitude of the lens-reflected light is determined to be greater than the threshold in operation 410, the position of the face, and the eye image may be acquired again using the gaze tracking module, and the lens-reflected light removal algorithm may be reperformed.

When P1 is determined to be less than P2 in operation 406, a left lighting may be determined to generate a reflected light. Accordingly, the two right lightings R_U and R_D and the upper left lighting L_U may be turned on, and the lower left lighting L_D may be turned off in operation 411.

In operation 412, a magnitude of another lens-reflected light may be measured, and may be compared with the threshold.

When the magnitude of the lens-reflected light is determined to be less than the threshold in operation 412, the coordinates of the final gaze position may be obtained using the gaze position calculation algorithm in operation 415. When the magnitude of the lens-reflected light is determined to be greater than the threshold in operation 412, the two right lightings R_U and R_D and the lower left lighting L_D may be turned on, and the upper left lighting L_U may be turned off in operation 413.

In operation 414, a magnitude of another lens-reflected light may be measured, and may be compared with the threshold.

When the magnitude of the lens-reflected light is determined to be less than the threshold in operation 414, the gaze position calculation algorithm may be performed in operation 415. When the magnitude of the lens-reflected light is determined to be greater than the threshold in operation 414, the position of the face, and the eye image may be acquired again using the gaze tracking module, and the lens-reflected light removal algorithm may be reperformed.

The remote gaze tracking method according to the embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A remote gaze tracking system, comprising:
an infrared lighting unit comprising a plurality of infrared lightings to emit an infrared light toward a user;
a gaze tracking module to track a position of a face of the user, and to collect, from the tracked position of the face, an eye image comprising at least one reflected light among a plurality of corneal reflected lights and a lens-reflected light, the corneal reflected lights being reflected from a cornea by the emitted infrared light, and the lens-reflected light being reflected from a lens of glasses; and
a processor to compare a magnitude of the lens-reflected light with a threshold in the collected eye image, and when the magnitude of the lens-reflected light is equal to or less than the threshold, to detect coordinates of a center of each of the plurality of corneal reflected lights, and to calculate a gaze position.

2. The remote gaze tracking system of claim 1, wherein, when the magnitude of the lens-reflected light is equal to or less than the threshold, the processor controls the plurality of infrared lightings so that a number of infrared lights emitted toward the user is adjusted.

3. The remote gaze tracking system of claim 2, wherein the processor controls an on state and/or off state of the plurality of infrared lightings, and adjusts the number of the emitted infrared lights,
wherein the processor calculates the gaze position, using an on state and/or off state of the plurality of infrared lightings corresponding to a lens-reflected light with a smallest magnitude among at least one lens-reflected light generated by the adjusted infrared light.

4. The remote gaze tracking system of claim 1, wherein the plurality of infrared lightings in the infrared lighting unit comprise an infrared lighting located in an upper left end of a display, an infrared lighting located in a lower left end of the display, an infrared lighting located in an upper right end of the display, and an infrared lighting located in a lower right end of the display.

5. A remote gaze tracking system, comprising:
an infrared lighting unit comprising a plurality of infrared lightings to emit an infrared light toward a user;
a gaze tracking module to track a position of a face of the user, and to collect, from the tracked position of the face, an eye image generated by the emitted infrared light; and
a processor to detect a lens-reflected light from the collected eye image, and to determine whether the user wears glasses.

6. The remote gaze tracking system of claim 5, wherein the processor measures a number of pixels in a central portion of the eye image that each have a gray level equal to or greater than a predetermined value, detects the lens-reflected light when the measured number of the pixels is equal to or greater than a threshold, and determines that the user wears the glasses when the lens-reflected light is detected.

7. A remote gaze tracking method, comprising:
emitting an infrared light toward a user, using a plurality of infrared lightings;
tracking a position of a face of the user, and collecting, from the tracked position of the face, an eye image comprising at least one reflected light among a plurality of corneal reflected lights and a lens-reflected light, the corneal reflected lights being reflected from a cornea by the emitted infrared light, and the lens-reflected light being reflected from a lens of glasses; and
comparing a magnitude of the lens-reflected light with a threshold in the collected eye image, and when the magnitude of the lens-reflected light is equal to or less than the threshold, detecting coordinates of a center of each of the plurality of corneal reflected lights, and calculating a gaze position.

8. The remote gaze tracking method of claim 7, wherein the comparing comprises, when the magnitude of the lens-reflected light is equal to or less than the threshold, controlling the plurality of infrared lightings so that a number of infrared lights emitted toward the user is adjusted.
